(19) United States
(12) Patent Application Publication
(10) Pub. No.: US 2024/0049828 A1
(43) Pub. Date: Feb. 15, 2024

(54) Wearable Hydraulic System And Shock Absorbing Device For Reducing Forces Due To Impact

(71) Applicant: Savior Brain Inc., Arlington, VA (US)

(72) Inventors: Jeffrey Daniel Allison, Lake Oswego, OR (US); Christoph Eduard Mack, Seattle, WA (US); Gordon Lee Avery, JR., Arlington, VA (US); Ryan Gundling, Staunton, VA (US); Ryan Long, Staunton, VA (US)

(21) Appl. No.: 18/221,107

(22) Filed: Jul. 12, 2023

Related U.S. Application Data
(60) Provisional application No. 63/368,158, filed on Jul. 12, 2022.

(51) Int. Cl. A42B 3/12

(52) U.S. Cl. CPC A42B 3/121

(57) ABSTRACT

A novel liquid-based system and shock absorber for reducing the forces experienced during high-energy impacts is provided. Individual shock absorbing devices can be used in parallel or in series to create a tunable network that is based on the specific energy absorption requirements for each application. Each shock absorbing device consists of a flexible, primary fluid-filled reservoir that, when impacted, ejects the liquid at high pressure through an array of orifices into a secondary flexible, low-pressure collection reservoir, where it is temporarily stored before the liquid returns to the primary reservoir where the device is ready for the next impact. Optionally, the shock absorbing device may be a single-use device, where the liquid ejects from but does not return to the reservoir.

### CROSS-REFERENCE TO RELATED APPLICATIONS

The present invention claims priority to U.S. Prov. Pat. App. No. 63/368,158, titled “Soft Wearable Hydraulic System for Reducing Forces Due To Impact,” filed Jul. 12, 2022, which is incorporated herein by reference in its entirety.

### STATEMENT REGARDING FEDERALLY SPONSORED RESEARCH OR DEVELOPMENT

This invention was made with government support under R43 NS119134 awarded by the National Institutes of Health. The government has certain rights in the invention.

### TECHNICAL FIELD

The present disclosure relates to a hydraulic system for impact protection for people and goods engaged in various activities and professions including athletics, transportation, military and first responders and industrial activities. Specifically, the present disclosure relates to a novel hydraulic system and shock absorbing device for reducing the forces transmitted to a person or item exposed to impact. Primary applications of the present hydraulic system and shock absorber are in protective articles such as helmets and body padding, surfaces which people or goods may impact, and shock isolation packaging with performance stability over a wide range of temperatures. In addition to reduction in transmitted impact forces, the present hydraulic system and shock absorbing devices can be useful in providing automatic adjustment for fit and comfort for wearable articles.

### BACKGROUND

Traditional methods of impact force mitigation have relied on the compression of stiff, closed-cell polymer foams, such as expanded polystyrene (EPS) and expanded polypropylene (EPP). Modern variants now include structures utilizing viscoelastic foams and rubbers. The traditional “stiff” materials are effective at passing regulatory body certification testing and preventing catastrophic skull fracture injury at high energy impacts but offer little attenuation of impacts of low and medium energy. Viscoelastic foams and rubbers may offer better performance over a larger range of impact energies but often have dramatically reduced efficacy in real-world applications where temperature extremes and environmental exposure reduce their performance.

A perfect shock absorber would use the entire physically available stroke at the minimum, constant force required for dissipation of the impact energy of a given event, over the full range of applicable use temperatures. The present hydraulic system utilizes liquid-based shock absorbing technology that provides a consistent force response that scales with impact energy and has minimal performance variation over a broad range of use temperatures.

### SUMMARY

The present disclosure relates to a novel liquid-based system and shock absorber for reducing the forces experienced during high-energy impacts. Individual shock absorbing components can be used in parallel or in series to create a tunable network that is based on the specific energy absorption requirements for each application. Each shock absorbing device consists of a flexible, primary fluid-filled reservoir that, when impacted, ejects the liquid at high pressure through an array of orifices into a secondary flexible, low-pressure collection reservoir, where it is temporarily stored before the liquid returns to the primary reservoir. Orifices are oriented approximately orthogonal to the normal direction of impact, thus translating potentially harmful energy in harmless directions.

A novel approach to creating liquid return pressure is described which is to provide internal spring force upon the inside of the primary reservoir of the shock absorbing device such that when the impact force has been removed, the primary reservoir springs back to its original shape, thus creating a lower (vacuum) pressure that resets the shock by naturally sucking the liquid back from the secondary reservoir into the primary reservoir. By varying the liquid viscosity and orifice geometries, a range of force attenuation characteristics can be achieved.

To this end, in an embodiment of the present disclosure, a shock absorbing device is provided. The shock absorbing device comprises a primary liquid reservoir containing a liquid, at least one secondary liquid collection reservoir fluidly connected to the primary liquid reservoir through an orifice, wherein the primary liquid reservoir is compressible upon impact releasing the liquid from the primary liquid reservoir through the orifice to the secondary liquid collection reservoir and dissipating the impact.

It is, therefore, an advantage and objective of the present disclosure to provide a liquid-based system and shock absorbing device for reducing the forces experienced during high-energy impacts.

It is another advantage and objective of the present disclosure to provide a hydraulic system, which utilizes liquid-based shock absorbing technology that provides a consistent force response that scales with impact energy and has minimal performance variation over a broad range of use temperatures.

Additional features and advantages of the present disclosure are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIGS. 1A-IC illustrate a cross-section showing the basic function of an individual hydraulic shock absorbing device during impact according to the present disclosure.

FIG. 2 illustrates a cross-section of the shock absorbing device in the uncompressed state according to the present disclosure.

FIG. 3 illustrates a cross-section of the shock absorbing device in the collapsed state according to the present disclosure.

FIG. 4 illustrates a cross-section of another embodiment of the shock absorbing device having a conical coil spring to create liquid return pressure according to the present disclosure.

FIG. 5 illustrates a cross-section of another embodiment of the shock absorbing device having flexible spring fingers to create liquid return pressure according to the present disclosure.

FIG. 6 illustrates a cross-section of yet another embodiment of the shock absorbing device having a low density open-cell foam (i.e., “reticulated foam”) used to create spring-like liquid return pressure according to the present disclosure.

FIG. 7 illustrates a cross-section of another embodiment of a shock absorbing device with low to medium density foam externally laminated to create spring-like liquid return pressure according to the present disclosure.

FIG. 8 illustrates a cross-section of another embodiment of the shock absorbing device with medium to high density foam or rubber externally adhered to a primary liquid reservoir fabric to create spring-like liquid return pressure according to the present disclosure.

FIG. 9 illustrates a cross-section of yet another embodiment of the shock absorbing device with plastic spring fingers applying force externally to the liquid collection chamber to create liquid return pressure according to the present disclosure.

FIG. 10 illustrates a cross-section of an embodiment of an orifice ring with integrated collapsing structure for added shock absorption at the end of the liquid stroke according to the present disclosure.

FIG. 11 illustrates a cross-section of an embodiment of a shock absorbing device having double height with formed chambers on both top and bottom of the device according to the present disclosure.

FIGS. 12A-12B illustrate a shock absorbing device utilizing pressure-activated, progressively adaptive orifice ports according to the present disclosure.

FIGS. 13A-13D illustrate a shock absorbing device utilizing sequential collection reservoirs to increase energy absorption according to the present disclosure. As the primary liquid chamber begins to compress (A), the liquid enters the first of the sequential reserves and it begins to inflate (B), until both the first and second reservoirs are at the same height (C) at which point both reservoirs continue to absorb impact and force liquid into additional reservoirs until all are equal height (D).

FIG. 14 illustrates an embodiment for reduced system mass applications of the present shock absorbing devices according to the present disclosure.

FIG. 15 illustrates a shock absorbing device in use in a football helmet according to the present disclosure.

FIGS. 16A-16E illustrate an array of shock absorbing devices employed to absorb shock in a helmet construction according to the present disclosure.

FIGS. 17A-17H illustrates an array of multiple shock absorbing devices sharing a common collection reservoir and how these may be utilized in various arrangements to cover various regions on a human head.

FIGS. 18A-18D illustrate another embodiment of a shock absorbing device wherein the liquid in the primary reservoir is enclosed in a fully sealed container and on impact of predetermined force or greater, the container is ruptured releasing the enclosed fluid, allowing it to flow

FIG. 19 illustrates yet another embodiment of a shock absorbing device having a series of interconnected primary and secondary collection reservoirs.

FIG. 20 illustrates a cross section A-A of the shock absorbing device of FIG. 19.

FIG. 21 illustrates a three-dimensional view of the shock absorbing device of FIG. 19.

### DETAILED DESCRIPTION

The present disclosure relates to a hydraulic system and shock absorbing device for reducing the forces transmitted to a person or item exposed to impact. The present disclosure also relates to a liquid-filled comfort and fit device, which is useful in wearable articles such as helmets. The liquid-filled device adjusts to the size and shape of the user's head, thereby providing a better, more comfortable fit when incorporated into a wearable item.

Hydraulic shock absorbers have been used for decades to reduce the forces transmitted during impacts. In a classic liquid shock absorber, an incompressible liquid is contained in a cylinder reservoir and a piston with small orifices is pushed through the liquid reservoir during an impact event. Energy is dissipated as the liquid squeezes through the orifices at high pressure. After the impact, the shock resets, typically by aid of an external spring that pushes the piston into its uncompressed state while check valves in the piston head allow for liquid to easily return to the reservoir.

A major limitation to traditional shock absorbers is that the available stroke can never be more than half the total length of the uncompressed system. Another limitation is the systems are typically constructed of heavy, rigid materials that limit their application for body-worn protection.

The present hydraulic system described herein is a soft hydraulic shock absorber that maximizes available energy absorption stroke through the use of strong flexible materials and flexible collection reservoirs. Potential applications for this technology are numerous and include wearable protective gear such as helmets, body padding and armor as well as many automotive and electronic protection systems, and/or anything that may be deemed fragile and/or high value. Additionally, the present device is useful as a comfort and fit device when incorporated into wearable items such as helmets or other forms of adjustable body padding because the fluid-filled nature of the device permits it to accommodate various configurations of the user.

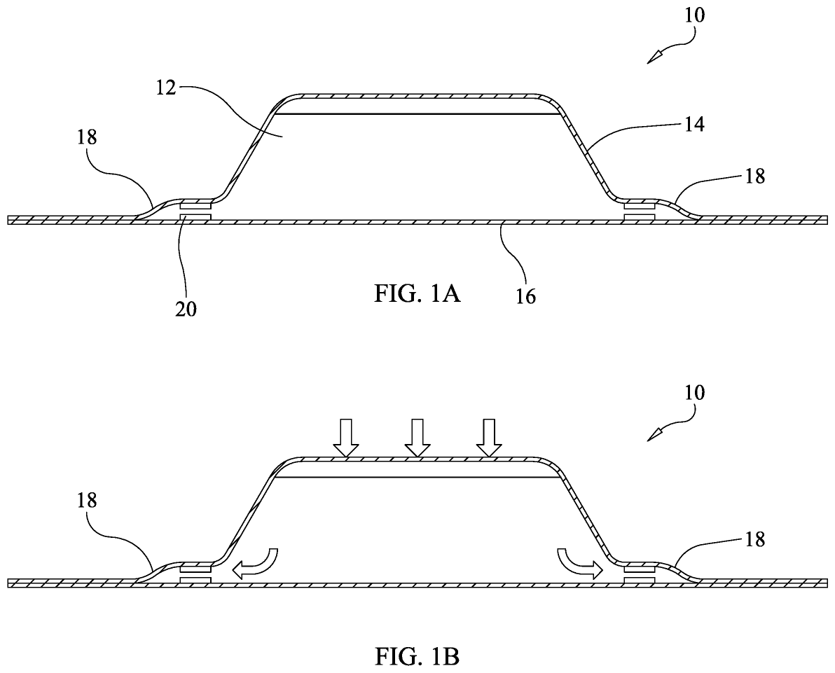

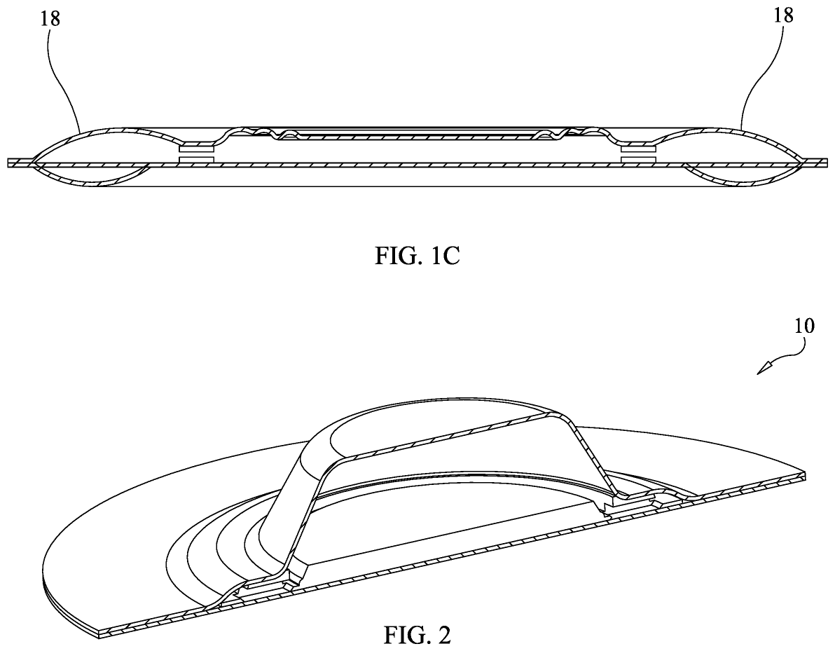

Now referring to the figures, wherein like numerals refer to like parts, FIG. 1 illustrates a cross-section showing the sequential function of an individual hydraulic shock absorbing device 10 during impact. Primary liquid reservoir 12 is created with flexible but high tensile strength waterproof fabric 14 which is bonded together. Optionally, the material may be bonded to a dense polymer orifice ring 16. The perimeter of the fabric 14 is also bonded together to create a secondary liquid collection reservoir 18 for liquid collection during impact. The primary liquid reservoir 12 is fluidly connected to the secondary liquid collection reservoir 18 through at least one orifice 20. If an orifice ring 16 is used in construction of the shock absorbing device 16, at least one or a plurality of orifices 20 are disposed within the orifice ring connecting the primary liquid reservoir 12 with the second liquid collection reservoir 18. Before an impact event, the primary liquid reservoir 12 is in a first expanded position where it is filled with a static liquid or fluid.

As shown in the sequence depicted in FIGS. 1A, 1B and 1C, impact to the primary liquid reservoir 12 initiates pressure which rapidly increases on the primary liquid reservoir causing liquid to jet through an orifice 20 or array of orifices and into the flexible secondary liquid collection reservoir 18 (FIG. 1B). The direction of the impact may be directly downward onto the top of the primary liquid reservoir 12, or the impact may be shearing or glancing off center to the top of the primary liquid reservoir. The secondary liquid collection reservoirs 18, which are positioned in close proximity to the primary liquid reservoir 12, fill with the displaced fluid from the primary liquid reservoir 12 (FIG. 1C).

The liquid used in the liquid reservoirs, as described herein, may be water, but may also include other fluids that enable the primary liquid reservoirs and, therefore, the shock absorbers as described herein to better absorb energy impacted thereto. Such fluids may include glycol, glycerin, gels, or other like fluids.

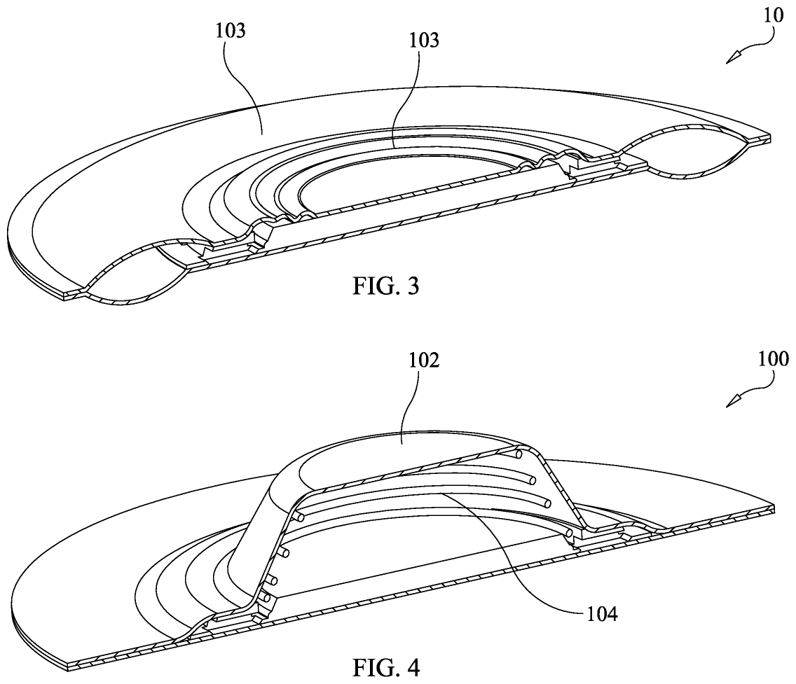

The energy required to accelerate the liquid through the orifices 20 effectively decelerates the impact energy and reduces the observed forces on the underlying support. In turn, as shown in FIGS. 2 and 3, the shock absorbing device 10 and specifically the primary liquid reservoir 12 goes from a first expanded position (FIG. 2) to a second compressed position (FIG. 3) during impact. In the second compressed position, the primary liquid reservoir may form a plurality of ridges, wrinkles, folds, or other like features 103 in the material (FIG. 3). These ridges, wrinkles, folds, or other like features 103 are also useful in dissipating the impact force on the shock absorbing device 10, such as, especially, shearing forces or glancing forces that may impact the primary liquid reservoir 12.

Shock absorbing devices 10 may be utilized in scenarios of single use impacts. Alternatively, the shock absorbing devices 10 may be reusable, wherein the primary liquid reservoirs may return to their original shape upon release of the impact pressure or by applying light pressure on the secondary collection liquid reservoirs to refill the primary liquid reservoir 12 to a state of readiness after the impact for subsequent impact events. In a single-use impact device, the liquid bursts from the primary reservoir 12 and does not return. When this happens, there may also be an indicator, such as a color added to the liquid to indicate that the device 10 has indeed been ruptured. Other indicators may include windows that show color changes when the primary reservoir 12 bursts, or visual changes in the primary reservoir 12 or the secondary collection liquid reservoirs 18.

Ideal reservoir materials are flexible and waterproof with very high tensile strength or adequate stiffness. Shock absorbing devices constructed from high tension fabrics do not require incorporation of an orifice ring. In one embodiment, the primary flexible reservoir 12 is composed of thermoformed Polyurethane coated Nylon fabric such as 420 Denier heat-weldable waterproof packcloth. Other reservoir materials include a range of waterproof cloth laminates and may be composite materials that incorporate 2 or more layers of material that include, polyester, vinyl, silicone, Mylar®, Dyneema® or similar, fiberglass, carbon fiber, aramid fiber, hemp fiber or others. Molded, insert-molded or formed plastic or rubber films can also be used. In the present invention, the use of the term “membrane” to describe the material that the shock absorbing devices are constructed from is meant to refer to any material (film, fabric, nonwoven, etc.) that may be utilized for the present invention. Moreover, the shock absorbing device 10 may have a flat top and bottom with steep hyperbolic cross-sectional curvature, however a steep-sided conical shape or mounded shape may also perform well, as well as any other irregular shapes.

In an optional embodiment, the primary liquid reservoir 12 is affixed to an orifice ring 16, as illustrated in FIG. 10. The orifice ring 16 includes at least one or more orifice openings 20 spaced radially around its perimeter and directed roughly orthogonal to the radial axis of the primary liquid reservoir. Orifice openings 20 connect the primary liquid reservoir 12 to the secondary liquid collection reservoir 18 or reservoirs. Orifice ring 16 may be injection-molded, cast or 3D-printed elastomeric material such as TPU, TPE, silicone or natural rubbers or it may be fabricated from a rigid plastic or metal material. Orifice size, number and shape can be varied, in conjunction with the volume/stroke of the primary liquid reservoir 12 as well as the dynamic viscosity of the hydraulic fluid, in order to tune the specific impact performance of the shock absorbing device 10. For example, a higher viscosity liquid will require more total orifice area compared with a low viscosity fluid, in order to achieve similar force response curves. Careful design of the orifice area and provision for primary liquid reservoir 12 cross-sectional area that increases with displacement allow for a nearly constant reaction force response across nearly the entirety of the physically available stroke for the range of impact energies encountered.

The secondary liquid collection reservoir 18 is directly connected to the primary liquid reservoir 12 through at least one orifice 20. Optionally, primary liquid reservoir 12 is remotely connected via tubes running from each orifice to one or more secondary liquid collection reservoirs 18. In one embodiment, the primary liquid reservoir 12 is disposed radially around orifice ring 16 and is comprised of two sheets of material that are bonded to the orifice ring and bond to one another at a circular interface, spaced from the orifice ring, such that cylindrical unbonded ring is available to receive liquid as it moves through the orifices 20 from the primary liquid reservoir 12. As the primary liquid reservoir 12 is compressed and liquid enters the secondary liquid collection reservoir 18, it will deform the bonded sheets and inflate to the shape of torus.

The secondary liquid collection reservoir 18 is created through regional bonding of the same contiguous sheet of membrane material that was formed to create the primary liquid reservoir 12. Use of a membrane material reduces the total number of parts required in construction of the device, and also reduces the potential for leaking, should a failure occur in the adhesive bond with the orifice ring 16. However, the secondary liquid collection reservoir 18 can be created in a number of ways that include separate inextensible but flexible pouches or by using extensible elastic materials that will stretch as liquid escapes from the primary liquid reservoir 12. Regions in the secondary liquid collection reservoir 18 may be locally welded to limit the extensibility of specific areas. This can allow for tailoring the shape of the inflated collection region. Through holes may be created within locally welded regions as well to enable connection between the top and bottom of the collection reservoir. Foam, plastic, or metal spring components may be joined via these locations to provide external spring force for liquid return to the primary liquid reservoir (FIGS. 4-7).

The shock liquid used in the present shock absorbing device 10 may be any relatively incompressible liquid although low-density, low-viscosity, non-toxic fluids with low freezing points are most desirable. In a preferred embodiment, a high percentage mixture of Propylene Glycol and water is desirable for its low-freezing point and low toxicity but other fluids such as water, mineral oil, isopropyl alcohol, or others may also be used depending on the application. Additionally, mixtures of various liquids or the addition of microspheres may be used to create specific viscosities or lower density solutions to reduce weight.

The liquid contained within the primary liquid reservoir 12 may be at a differential partial pressure to its counterpart (i.e., water vapor) present in the atmosphere surrounding the chamber. To counter liquid mass gain and/or loss due to osmotic vapor transport across partially permeable fabric laminations, a proportion of water will be provided to the shock liquid mixture sufficient to permeate the membrane across the range of anticipated relative humidities encountered during use, maintaining the acceptable range of nominal volumes of the shock chamber.

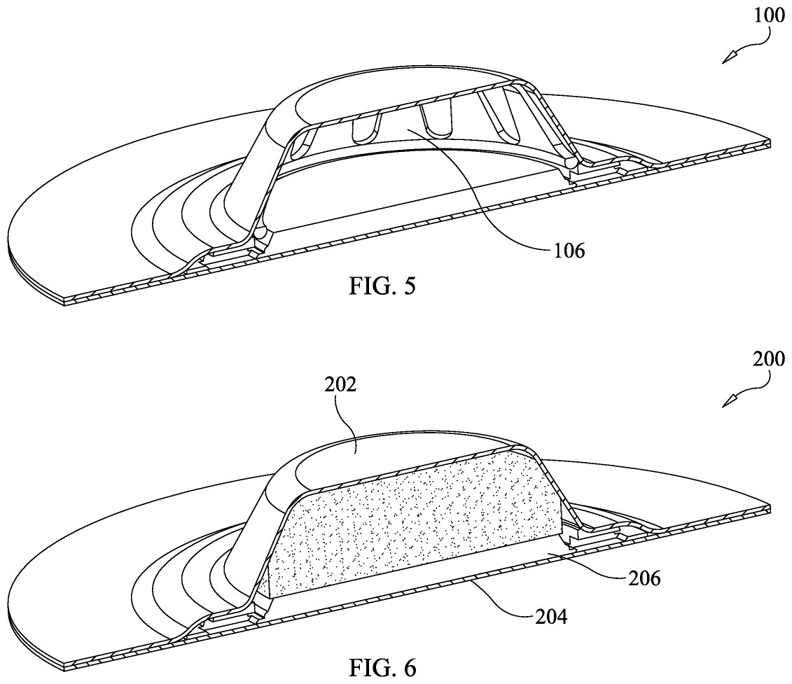

FIGS. 4 and 5 illustrate another embodiment of a shock absorbing device 100 of the present disclosure. In this embodiment, the primary liquid reservoir 102 incorporates internal springs such as coil springs 104 or plastic spring fingers 106 inside the primary liquid reservoir. The springs 104 create liquid return pressure in the primary liquid reservoir, which assist the primary y liquid reservoir to return to its original, pre-impact structure. The springs 104 may be constructed from foam, spring fingers, or air bladders. Optionally, the springs 104 may be laminated to the primary liquid reservoir 12 itself to spring it back to its original shape.

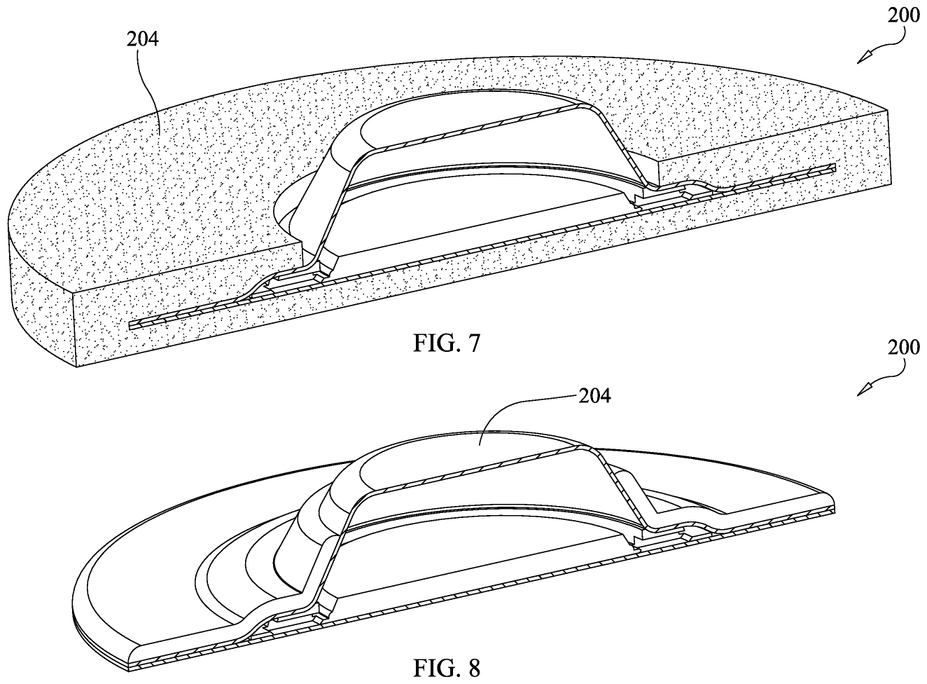

FIGS. 6 and 7 illustrate another embodiment of a shock absorbing device 200 of the present disclosure. In this embodiment, the primary liquid reservoir 202 is filled with a low-density open-celled elastic foam material 204, such as reticulated Polyurethane foam. When impact load is removed from the primary reservoir 202, the foam 204 will return to its uncompressed state and force the primary liquid reservoir material into its original shape, lowering the pressure in the reservoir chamber and sucking the shock liquid back from the collection reservoir(s) 106. The primary liquid reservoir 202 is again ready for subsequent impacts. FIG. 8 illustrates a cross-section of another embodiment of the shock absorbing device 200 with medium to high density foam 204 or rubber externally laminated to the chamber fabric to create spring-like liquid return pressure according to the present disclosure.

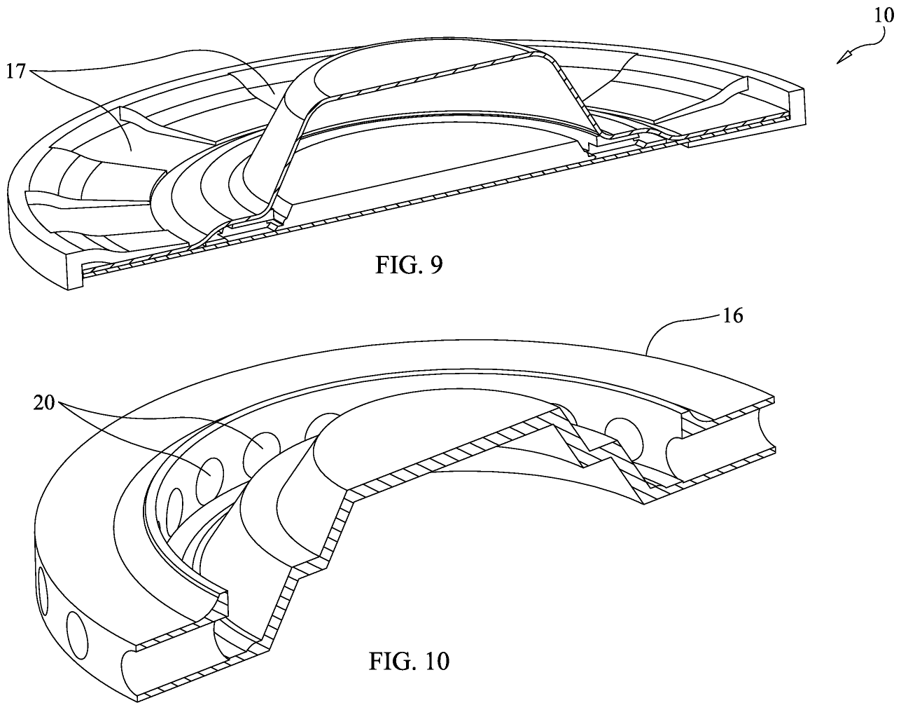

FIG. 9 illustrates an embodiment of a shock absorbing device wherein the orifice ring 16 may be eliminated in favor of orifice channels 17 created by selective welding of the top and bottom primary reservoir layers. In this embodiment, the unwelded regions of the primary reservoir and collection reservoir would be connected by radial unwelded channels 17, like the spokes of a wagon wheel. This configuration allows for minimal total parts and maximum shock stroke.

In yet another embodiment of the shock absorbing device individual reservoirs may be joined via common collection reservoirs. Two or more primary liquid reservoirs, each with its own orifice ring, may be mutually attached to a common secondary liquid collection reservoir. Such an arrangement may enable desirable geometries and shock spacing, reduce total part count and provide assembly efficiency.

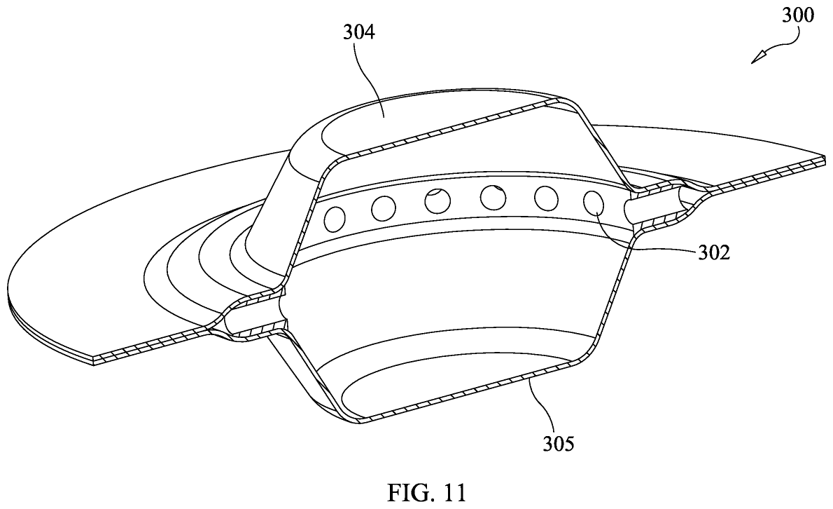

FIG. 11 illustrates another embodiment of the shock absorbing device 300 wherein, two formed fabric parts may be bonded on either side of an orifice ring 302 to create primary fluid reservoirs chambers on both top 304 and bottom 305, creating a device having a double primary liquid reservoir. This configuration allows for twice the available shock stroke and may be desirable for many applications.

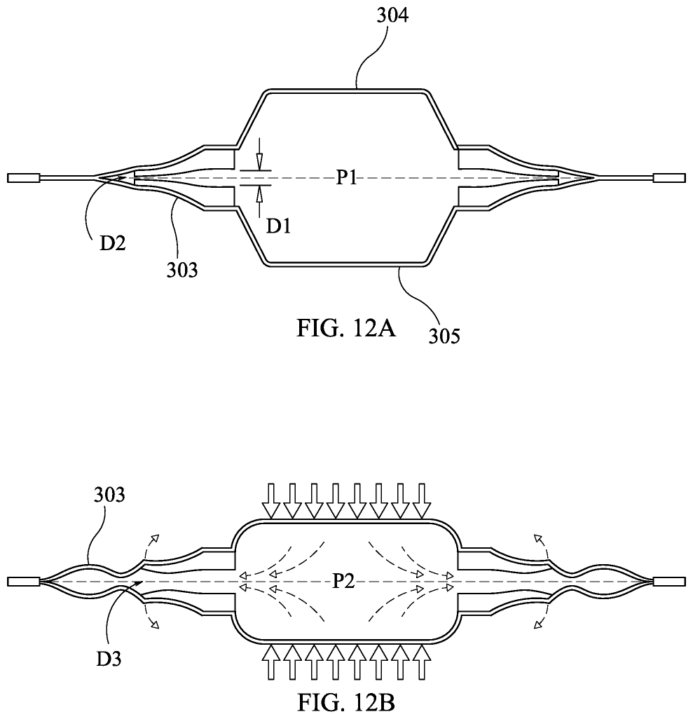

FIG. 12 illustrates the shock absorbing device 300 utilizing pressure-activated, progressively adaptive orifice ports 302 according to the present disclosure. Flexible polymer material and tapered geometries in the orifice 302 enables the orifice cross-sectional area 303 to increase as pressure increases. For example, in FIG. 12A, the initial diameters D1 and D2 of the orifice 303 sequentially increases to D3 as the impact pressures increase (P1 to P2) forcing the fluid from the primary liquid reservoir 301 out through the orifice 303 (FIG. 12B). In this way, orifice 302 can adapt for higher flow rates during higher energy impacts on both the top 304 and bottom 305 of the primary liquid reservoir 301.

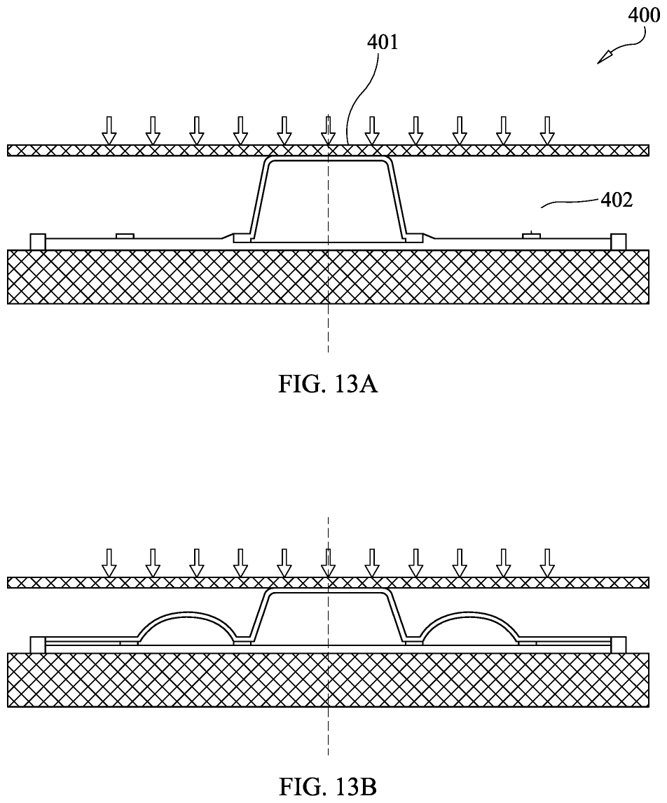

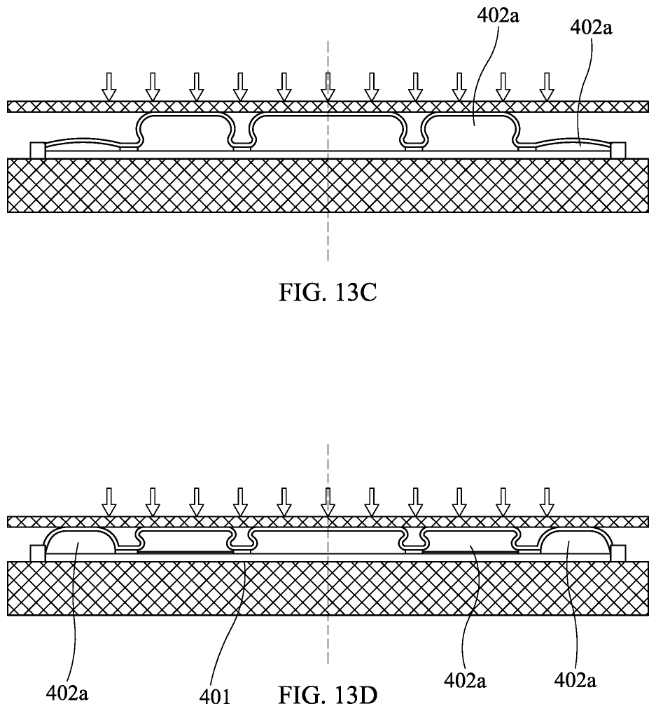

FIG. 13 illustrates another embodiment of the shock absorbing device 400 wherein the secondary liquid collection reservoir 402 can be fabricated such that a series of sequentially engaged secondary liquid collection reservoir chambers 402a are filled by the liquid leaving the primary reservoir 401. As each collection reservoir 402a is filled, it inflates to a height greater than the fully compressed height of the shock absorbing device 400 (B and C). As an impact compresses the shock absorbing device 400 further, each collection reservoir 402a fills until all collection reservoirs are filled and are of equal compressed height (D). In this way, the same liquid volume can be used to dissipate impact energy multiple times during a single impact event.

FIG. 14 illustrates an embodiment for reduced system mass applications for the shock absorbing devices of the present disclosure. Minimization of system mass is anticipated to be of critical importance to several use cases. Coaxial shock chambers provide a central volume of liquid surrounded and supported by an annular volume of foam, air, and/or other gases. Since the volume of a cylinder or truncated cone is proportional to the square of the radius, reduction of cross-sectional diameter by a factor of two results in a reduction of liquid volume (and therefore liquid mass) by a factor of 4. As shock chamber cross-sectional area decreases, maintaining equivalent reaction force response may require significantly higher system pressures, which may require the use of ultra-high strength and stiffness fabric laminates, such as fiber reinforced elastomer composites, employing high performance fiber fabrics such as carbon fiber, fiberglass, aramid, spectra, and Dyneema®. Additionally, convolutions in the waterproof fabric structure geometry reduce the in-plane stresses for a given pressure. Creating a “bellows-like” convoluted configuration may alleviate the requirement for use of the highest strength fibers.

FIG. 15 illustrates a shock absorbing device 10 in use in a football helmet 500 according to the present disclosure. Any one of the embodiments of shock absorbing devices described here may be used on the helmet. One or more shock absorbing devices 10 may be combined to share secondary collection reservoirs, as appropriate, to effectively cover a protection zone.

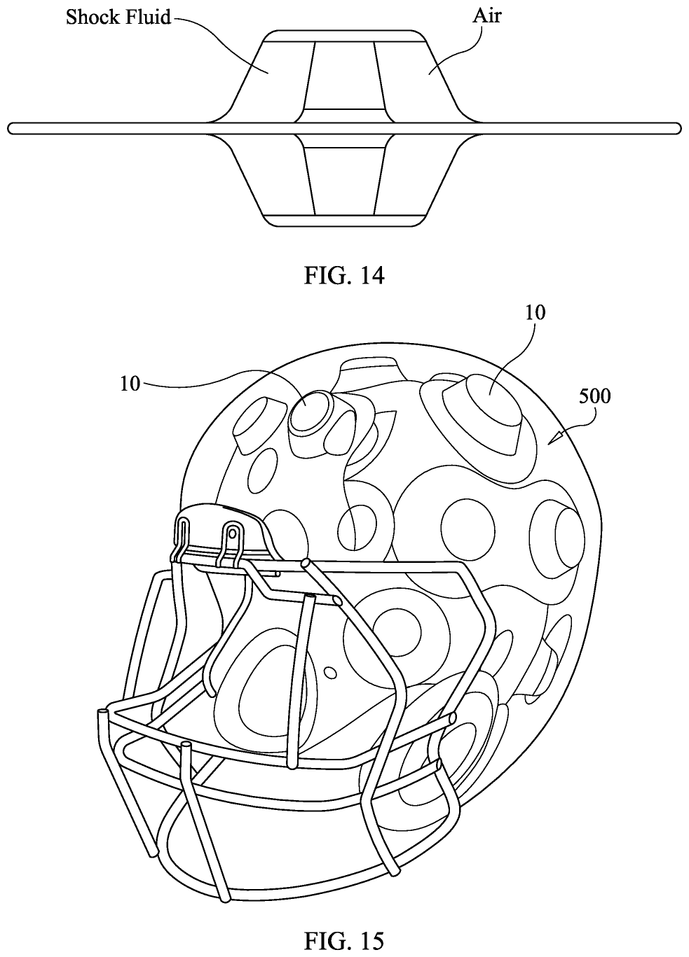

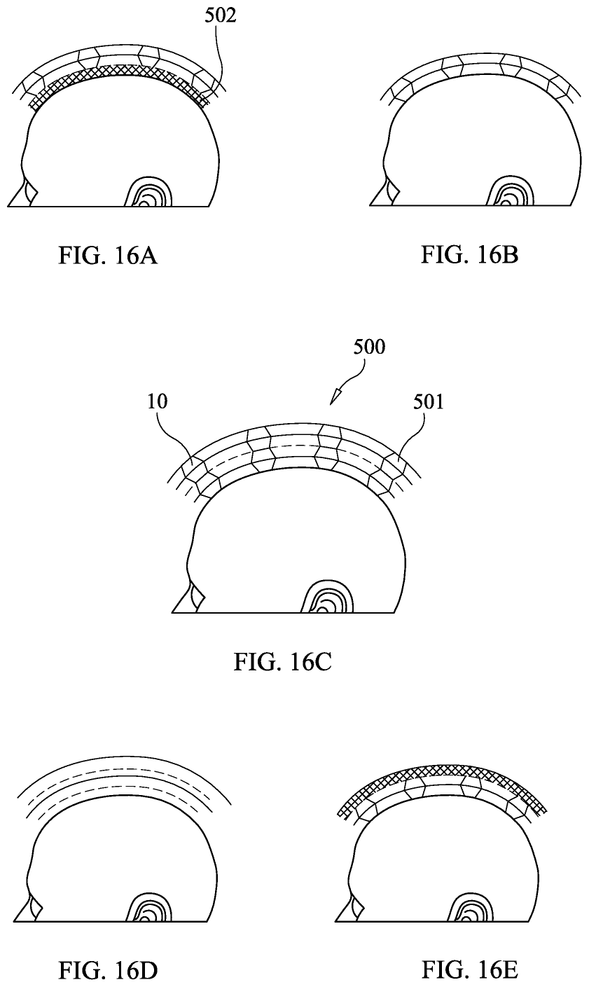

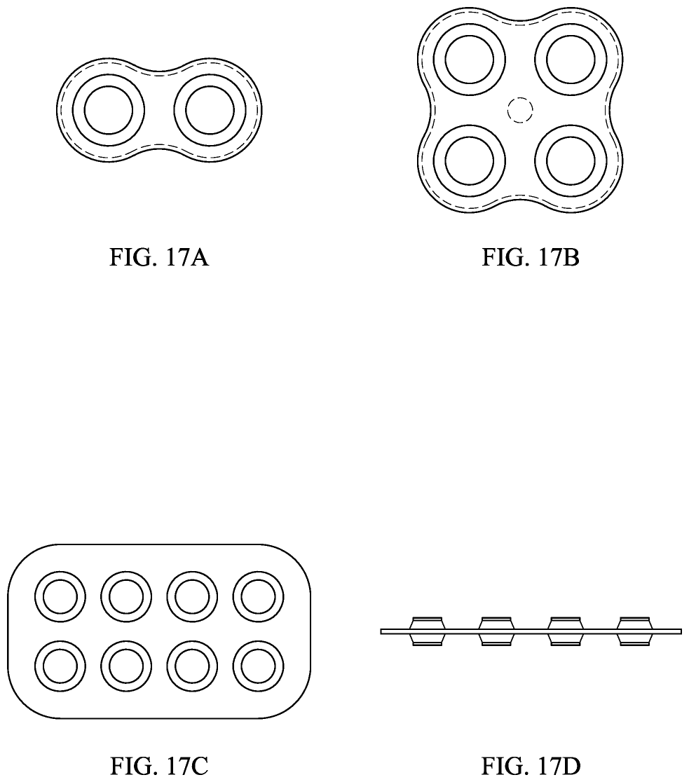

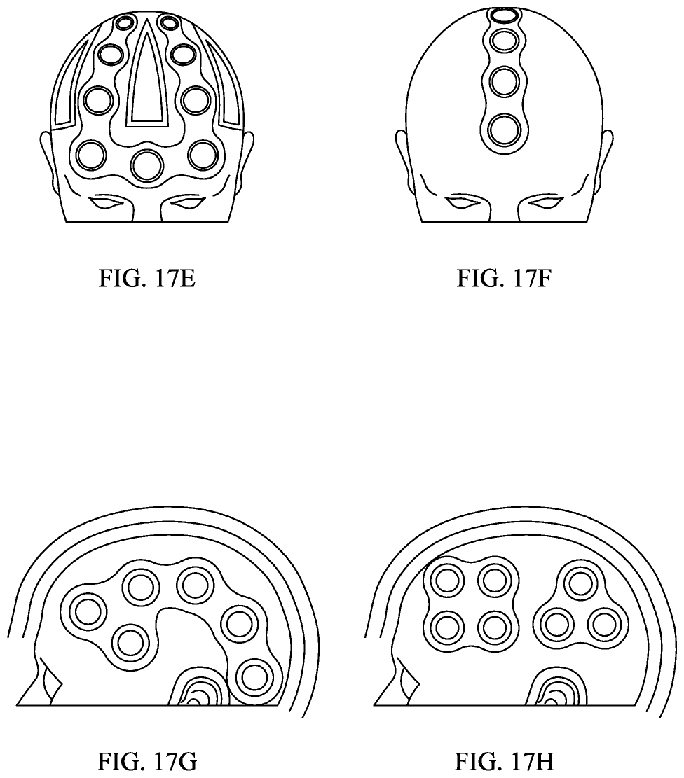

FIG. 16 illustrates an array of shock absorbing devices 10 employed to absorb shock in a helmet construction according to the present disclosure. Shock absorbing devices may be positioned between the rigid outer helmet shell 501 and other rigid layers of protective foam 502 (A, D, E) or be utilized as an inner comfort/cushion layer (B). Shock absorbing devices may be configured to operate as independent fluidic systems or as fluidically communicating networks, sharing flow circuits and common reservoirs. Configurations of one, two, three, or four, or more individual shock absorbing devices may be interconnected to provide customized coverage areas and tailored impact attenuation response (C). Also contemplated are large numbers of small liquid chamber “cells” in fluidic communication and/or standalone configuration, such as those illustrated in FIGS. 17A-17H. Similar to air filled “bubble wrap” sheet products, this embodiment may comprise a large number (i.e., 20, 50, 100 or more) of relatively small (i.e., <15 mm diameter and <15 mm axial height) liquid capsules arranged on a flat pattern plane, articulated to be conformable to a curved surface similar to that of a human head or other body part.

In another embodiment of the present invention, an array of multiple shock absorbing devices may share a common collection reservoir and how these may be utilized to cover various regions on a human head. For example, the present invention may include a plurality of primary liquid reservoir chambers, each of which may be connected in fluid relationship with a single liquid collection reservoir chamber such that each of the plurality of primary fluid reservoir chambers may selectively or together, depending on the force applied thereto, cause fluid to flow from the primary fluid reservoir chambers into the single fluid collection reservoir chamber.

It should be understood that the arrangement of shock absorbing devices provided in the present disclosure may also be used to provide comfort and proper fit in a wearable article or item. For example, any particular arrangement of the shock absorbing devices provided in the present disclosure may be useful for wearable items, such as a helmet, such that the helmet can be worn by a variety of head shapes. The fluid-filled nature of the present devices enable the devices to change and adjust as needed to ensure the wearer has a firm and comfortable fit to the item, regardless of head shape. For example, fluid may flow between reservoirs to adjust the form of the reservoirs to better fit a user. Also, membranes utilized to form the shock absorbing devices described herein may stretch to better fit a user. Of course, any other mechanism may be utilized to form a better fit for a user when utilized.

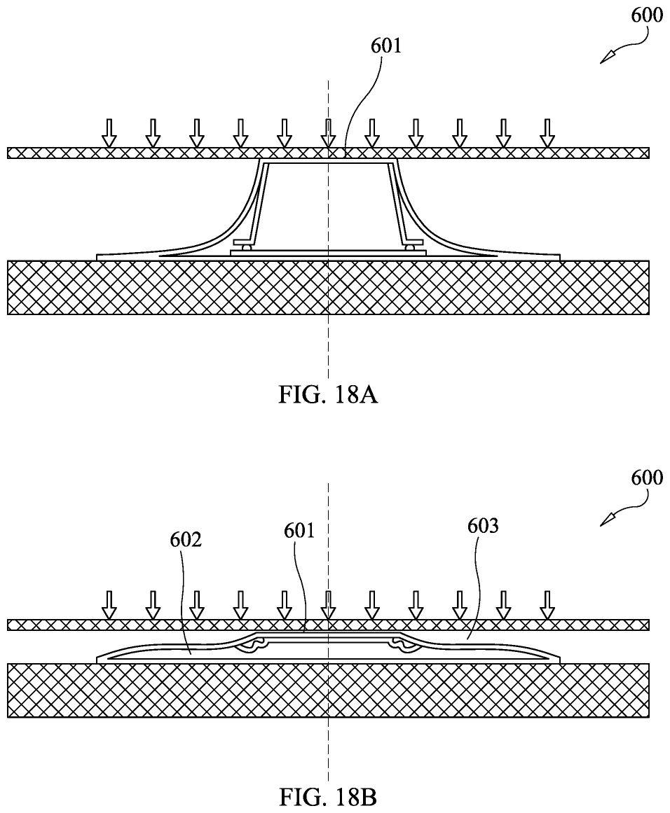

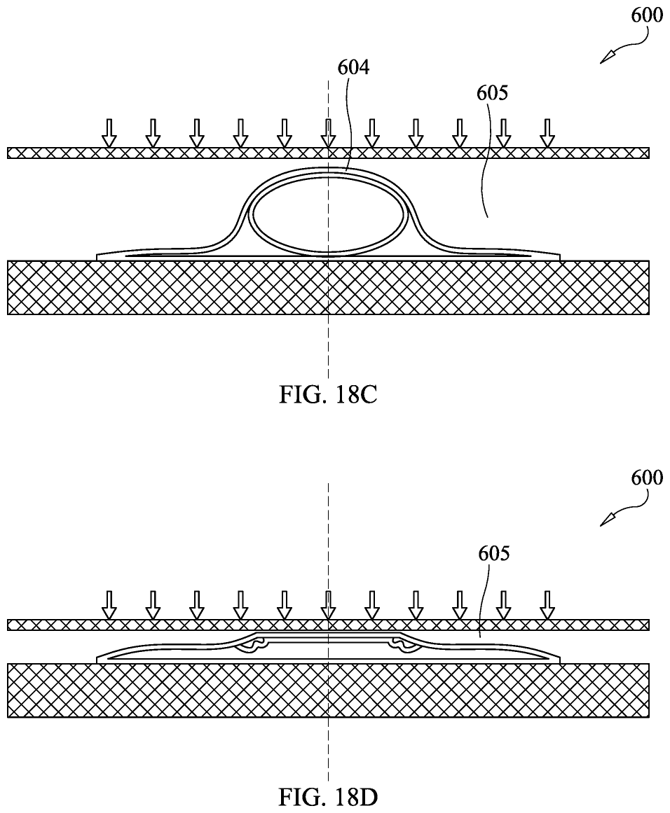

FIG. 18 illustrates an embodiment of a shock absorbing device 600 in which the liquid in the primary liquid reservoir chamber 601 statically contained by one or more seals obstructing one or more orifice ports (FIG. 18A). At a predetermined design pressure threshold, the orifice seals 602 may burst, allowing rapidly accelerated liquid flow to occur and absorbing impact energy (FIG. 18B). These burst seals 602 may also be joined seams designed to separate at predetermined pressure levels. The shock liquid, once jettisoned from the primary liquid reservoir chamber 601, may be caught and contained by a surrounding, impermeable liquid capture bag 603 (FIG. 18B). This bag 603 can be made of thin, flexible plastic film of sufficient size and strength to contain high velocity jets of shock liquid and may be transparent or translucent to allow visual indication of the change of state of the burst seals. Shock liquid may be dyed a vibrant color to facilitate visual communication of the change of state of the shock absorber. Alternatively, the primary chamber may be provided in the form of a “gel-cap,” a capsule 604 made of polymer material statically containing shock liquid and designed to rupture at a predetermined pressure (FIG. 18C). Upon the capsule's 604 rupture, the shock liquid is jettisoned at high velocity into a surrounding liquid capture bag 605, where it provides visual indication of change of state of the shock chamber (FIG. 18D).

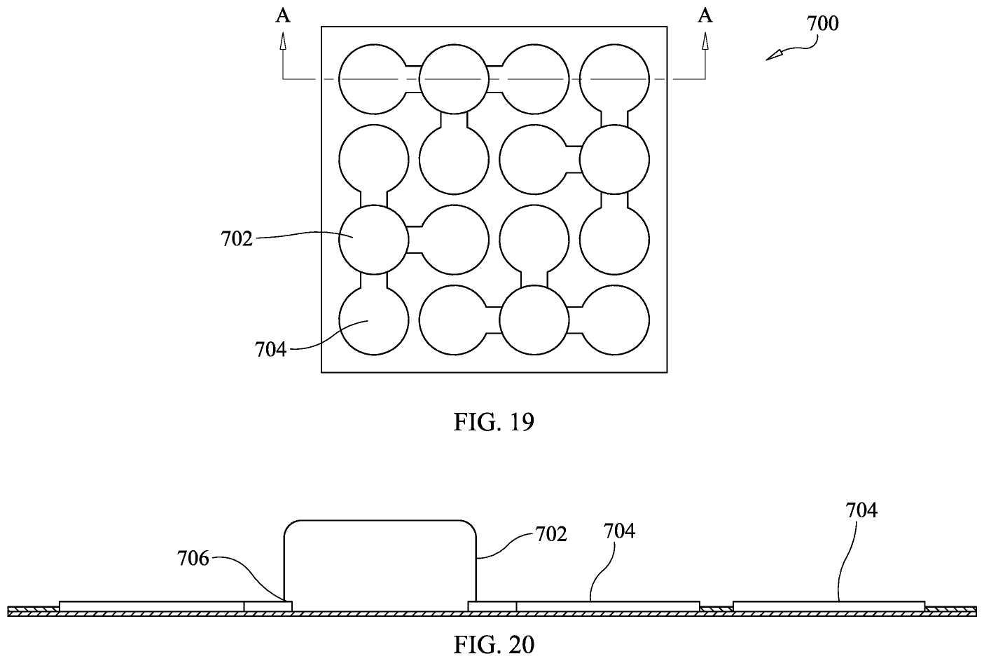

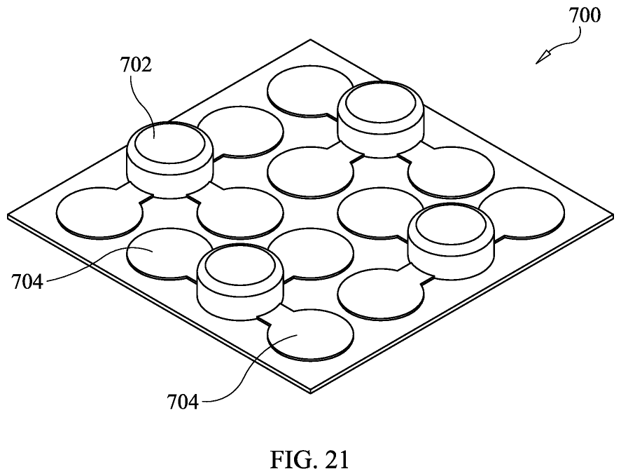

FIGS. 19-21 illustrate an exemplary embodiment of an assembly of shock absorbing devices 700. The assembly 700 includes a series of interconnected primary liquid reservoirs 702 and secondary liquid collection reservoirs 704. The primary liquid reservoirs 702 may be fluidly connected to the secondary liquid collection reservoirs 704 through orifices 706, as previously described. The present assembly of shock absorbing devices 700 are useful for positioning in multiple areas of any article needing impact protection and/or comfort and fit adjustability. The assembly of shock absorbing devices 700 may be formed from a pair of heat sealable membranes that may be heat sealed together, with fluid filled primary liquid reservoirs 702, secondary liquid collection reservoirs 704 and orifices 706 between the primary liquid reservoirs 702 and the liquid collection reservoirs 704. Although the orifices may form open passages, fabric or membrane tension on the orifices may hold the fluid in the primary liquid reservoirs 702 until a sufficient force is applied to the primary liquid reservoirs 702, at which time the fluid may force open the orifices 706 to allow fluid to flow therethrough into the liquid collection reservoirs 704. In a preferred embodiment, once the force is removed, the fluid may flow back through the orifices from the liquid collection reservoirs 704 back into the primary liquid reservoirs 702 for multiuse applications.

The present shock absorbing devices may also be provided as a single-use embodiment, where no return system is required for the fluid. Engineered seals or check valves may rupture or open when a predetermined pressure threshold has been reached. Liquid may be allowed to simply escape or it may be collected by housing all or part of the shock absorbing device inside a thin waterproof membrane such as a low-density polyethylene or silicone bag. Such a configuration could also use colored liquid to indicate to the user that a shock rupture has occurred.

The orifices 706 may be selectively expandable or constrictive based on a number of factors, including the material that may be used, the force applied to the primary liquid reservoirs 702, the location of the forces applied to the primary liquid reservoirs, the vectors of the forces applied to the primary liquid reservoirs, and/or other factors. Thus, the rate of fluid flow between the primary liquid reservoirs 702 and the liquid collection reservoirs 704 may be controlled for different applications.

It should be noted that various changes and modifications to the presently preferred embodiments described herein will be apparent to those skilled in the art. Such changes and modifications may be made without departing from the spirit and scope of the present disclosure and without diminishing its attendant advantages. Moreover, the disclosure illustratively disclosed herein suitably may be practiced in the absence of any element which is not specifically disclosed herein.

We claim:

1. A shock absorbing device comprising:
a primary liquid reservoir containing a liquid;
at least one secondary liquid collection reservoir fluidly connected to the primary liquid reservoir through an orifice;
wherein the primary liquid reservoir is compressible upon an impact releasing the liquid from the primary liquid reservoir through the orifice to the secondary liquid collection reservoir and dissipating the impact.

2. The shock absorbing device of claim 1, wherein the device further includes an orifice ring having a plurality of orifices disposed around a perimeter of the orifice ring.

3. The shock absorbing device of claim 1 wherein the device includes a first secondary liquid collection reservoir and a second secondary liquid collection reservoir, wherein each reservoir is positioned in close proximity to the primary liquid reservoir.

4. The shock absorbing device of claim 3, wherein the first secondary liquid collection reservoir and the second secondary liquid collection reservoir are each separately fluidly connected to the primary liquid reservoir through at least one orifice.

5. The shock absorbing device of claim 4, wherein the first and secondary liquid collection reservoirs are filled with the liquid from the primary liquid reservoir after compression of the primary liquid reservoir upon impact.

6. The shock absorbing device of claim 4, wherein the primary liquid reservoir is temporarily compressed from a first position into a second position after impact and release of the liquid into the first and second liquid collection reservoirs.

7. The shock absorbing device of claim 1, wherein the primary liquid reservoir is compressed into the second position and comprises a wrinkled or folded surface configuration.

8. The shock absorbing device of claim 1 wherein the primary liquid reservoir is compressed into the second position via a force normal to a top surface of the primary liquid reservoir.

9. The shock absorbing device of claim 1 wherein the primary liquid reservoir is compressed into the second position via an angular force to a top surface of the primary liquid reservoir.

10. The shock absorbing device of claim 1, wherein the liquid returns from the first and second secondary liquid collection reservoirs to the primary liquid reservoir expanding the primary liquid reservoir to the first position.

11. The shock absorbing device of claim 1, wherein the primary liquid reservoir contains a spring or foam disposed within an interior of the primary liquid reservoir.

12. The shock absorbing device of claim 11, wherein the spring or foam returns the primary liquid reservoir from the second collapsed position into the first uncollapsed position.

13. A shock absorbing device comprising:
a primary liquid reservoir containing a liquid;
a first secondary liquid collection reservoir and a second secondary liquid collection reservoir, wherein each liquid collection reservoir is positioned proximate to the primary liquid reservoir;
wherein the primary liquid reservoir is capable of changing configuration from a first shape to a second shape upon an impact to the primary liquid reservoir and releasing the liquid through a first orifice to the first secondary liquid collection reservoir and dissipating the impact or through a second orifice to the second secondary liquid collection reservoir and dissipating the impact or through both the first orifice and the second orifice.

14. The shock absorbing device of claim 13, wherein the primary liquid reservoir is configured to return to the first shape after the impact.

15. The shock absorbing device of claim 13 further comprising:
a first barrier at the first orifice;
a second barrier at the second orifice,
wherein the impact causes the fluid to break the first barrier, the second barrier, or both the first barrier and the second barrier.

16. A system of using a shock absorbing device comprising:
an article; and
a shock absorbing device on the article, the shock absorbing device comprising a primary liquid reservoir containing a static liquid and at least one secondary liquid collection reservoir fluidly connected to the primary liquid reservoir by an orifice;
wherein the primary liquid reservoir is compressible upon impact releasing the liquid through the orifice to the secondary liquid collection reservoir.

17. The system of claim 16 wherein the article is a helmet or padding.

18. The system of claim 16, wherein the secondary liquid collection reservoir fills with the liquid from the primary liquid reservoir upon impact to the primary liquid reservoir dissipating a force from the impact.

19. The system of claim 16, wherein the liquid returns from the secondary liquid collection reservoir to the primary liquid reservoir upon release of the impact.

20. The system of claim 16 further comprising:
a barrier at the orifice,
wherein the impact causes the fluid to break the barrier.
